(19) United States
(12) Patent Application Publication
(10) Pub. No.: US 2026/0093608 A1
(43) Pub. Date: Apr. 2, 2026

(54) METHOD AND SYSTEM FOR AUTOMATED TEST CASE GENERATION

(71) Applicant: HCL Technologies Limited, New Delhi (IN)

(72) Inventors: Srinivas Tangirala, Hyderabad (IN); Narender Siddhamshetty, Hyderabad (IN); Srihari Varadharajan, Chennai (IN); Kiran Ayyagari, Hyderabad (IN); Nidhin A. Unnithan, Chennai (IN); Sri Gayathri Paaraa P, Chennai (IN)

(21) Appl. No.: 19/085,599

(22) Filed: Mar. 20, 2025

(30) Foreign Application Priority Data
Sep. 30, 2024 (IN) 202411073999

(51) Int. Cl. G06F 11/3668; G06F 8/10; G06F 40/295

(52) U.S. Cl. CPC G06F 11/3684; G06F 8/10; G06F 40/295

(57) ABSTRACT

A method for automated test case generation is disclosed. The method includes receiving one or more requirements in natural language from a user device. Each of the one or more requirements includes an associated set of test scenarios. The method further includes generating one or more test cases for each requirement of the one or more requirements in a predefined template using a pre-configured Large Language Model (LLM). Each of the one or more test cases implements one of the associated set of test scenarios, and includes a plurality of test steps, test data corresponding to each of the plurality of test steps, and expected results of each of the plurality of test steps. The method further includes validating the one or more test cases based on a set of test validation parameters. Upon successful validation, the method further includes generating an output file in a predefined format.

### TECHNICAL FIELD

This disclosure relates generally to test case generation, and more particularly to method and system for automated test case generation.

### BACKGROUND

The Software Testing Life Cycle (STLC) is a crucial phase in the Software Development Life Cycle (SDLC) that involves several stages, such as requirement analysis, test planning, test case generation, test case execution, etc., each with specific objectives and deliverables. In STLC, from requirement analysis to test case execution, manual efforts are involved at each phase to perform the tasks.

In the present state of art, initial phase of STLC including requirement gathering, test planning, test case generation, and test case execution is done manually in most of the scenarios. Conventional test automation frameworks available in the market are designed for automation of test case execution and reporting. The conventional test automation frameworks receive test case documents containing test cases for a project. However, the test cases including test steps are developed into test scripts or specific templates manually by the developers based on test automation framework requirements for the test case execution. The test automation framework may then execute the test cases to validate the actual and expected results of the executed test case. Thus, there are various web and mobile application testing frameworks available in market with several methodologies to execute the test cases. However, such testing frameworks require test cases to be manually generated. Manual test case generation may be time-consuming, labor intensive, and prone to error.

The present invention is directed to overcome one or more limitations stated above or any other limitations associated with the known arts.

### SUMMARY

In one embodiment, a method for automated test case generation is disclosed. In one example, the method may include receiving one or more requirements in natural language from a user device. It should be noted that each of the one or more requirements may include an associated set of test scenarios. The method may further include generating one or more test cases for each requirement of the one or more requirements in a predefined template using a pre-configured Large Language Model (LLM). It should be noted that each of the one or more test cases corresponds to one of the associated set of test scenarios. It should also be noted that each of the one or more test cases may include a plurality of test steps, test data corresponding to each of the plurality of test steps, and expected results of each of the plurality of test steps. The method may further include validating the one or more test cases based on a set of test validation parameters. It should be noted that the set of test validation parameters may include test case functionality, test data, and scenario coverage. Upon successful validation, the method may further include generating an output file in a predefined format. It should be noted that the output file may include the one or more test cases.

In another embodiment, a system for automated test case generation is disclosed. In one example, the system may include a processor and a computer-readable medium communicatively coupled to the processor. The computer-readable medium may store processor-executable instructions, which, on execution, may cause the processor to receive one or more requirements in natural language from a user device. It should be noted that each of the one or more requirements may include an associated set of test scenarios. The processor-executable instructions, on execution, may further cause the processor to generate one or more test cases for each requirement of the one or more requirements in a predefined template using a pre-configured Large Language Model (LLM). It should be noted that each of the one or more test cases corresponds to one of the associated set of test scenarios. It should also be noted that each of the one or more test cases may include a plurality of test steps, test data corresponding to each of the plurality of test steps, and expected results of each of the plurality of test steps. The processor-executable instructions, on execution, may further cause the processor to validate the one or more test cases based on a set of test validation parameters. It should be noted that the set of test validation parameters may include test case functionality, test data, and scenario coverage. Upon successful validation, the processor-executable instructions, on execution, may further cause the processor to generate an output file in a predefined format. It should be noted that the output file may include the one or more test cases.

In yet another embodiment, a non-transitory computer-readable medium storing computer-executable instructions for automated test case generation is disclosed. In one example, the stored instructions, when executed by a processor, may cause the processor to perform operations including receiving one or more requirements in natural language from a user device. It should be noted that each of the one or more requirements may include an associated set of test scenarios. The operations may further include generating one or more test cases for each requirement of the one or more requirements in a predefined template using a pre-configured Large Language Model (LLM). It should be noted that each of the one or more test cases corresponds to one of the associated set of test scenarios. It should also be noted that each of the one or more test cases may include a plurality of test steps, test data corresponding to each of the plurality of test steps, and expected results of each of the plurality of test steps. The operations may further include validating the one or more test cases based on a set of test validation parameters. It should be noted that the set of test validation parameters may include test case functionality, test data, and scenario coverage. Upon successful validation, the operations may further include generating an output file in a predefined format. It should be noted that the output file may include the one or more test cases.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for automated test case generation, in accordance with some embodiments of the present disclosure.

FIG. 2 illustrates a functional block diagram of various modules within a memory of a computing device configured for automated test case generation, in accordance with some embodiments of the present disclosure.

FIG. 3 illustrates a flow diagram of an exemplary process for automated test case generation, in accordance with some embodiments of the present disclosure.

FIG. 4 illustrates an exemplary requirement sheet, in accordance with some embodiments of the present disclosure.

FIG. 5 illustrates an exemplary output file, in accordance with some embodiments of the present disclosure.

FIGS. 6A and 6B are tables representing segmentation of test steps, in accordance with some embodiments of the present disclosure.

FIG. 7 illustrates an exemplary processed output file, in accordance with some embodiments of the present disclosure.

FIG. 8 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

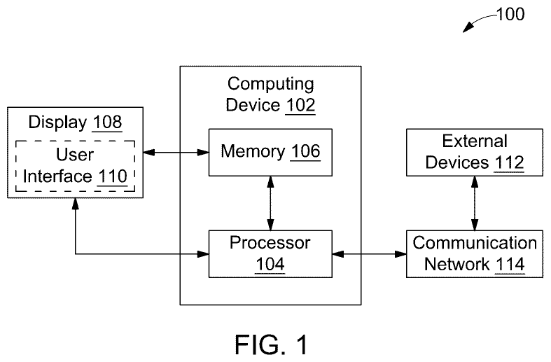

Referring now to FIG. 1, an exemplary system 100 for automated test case generation is illustrated, in accordance with some embodiments of the present disclosure. The system 100 may include a computing device 102. The computing device 102 may be, for example, but may not be limited to, server, desktop, laptop, notebook, netbook, tablet, smartphone, mobile phone, or any other computing device, in accordance with some embodiments of the present disclosure. The computing device 102 may automate test case generation using generative Artificial Intelligence (AI).

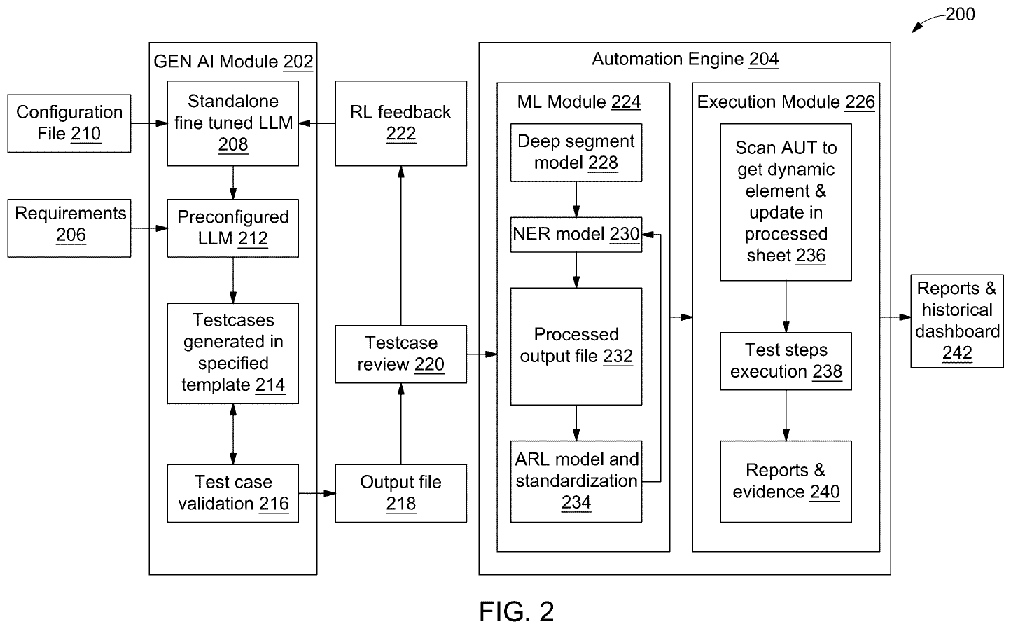

As will be described in greater detail in conjunction with FIG. 2-8, the computing device 102 may receive one or more requirements in natural language from a user device. It should be noted that each of the one or more requirements may include an associated set of test scenarios. The computing device 102 may further generate one or more test cases for each requirement of the one or more requirements in a predefined template using a pre-configured Large Language Model (LLM). It should be noted that each of the one or more test cases corresponds to one of the associated set of test scenarios. It should also be noted that each of the one or more test cases may include a plurality of test steps, test data corresponding to each of the plurality of test steps, and expected results of each of the plurality of test steps. The computing device 102 may further validate the one or more test cases based on a set of test validation parameters. It should be noted that the set of test validation parameters may include test case functionality, test data, and scenario coverage. Upon successful validation, the computing device 102 may further generate an output file in a predefined format. It should be noted that the output file may include the one or more test cases.

In some embodiments, the computing device 102 may include one or more processors 104 and a memory 106. Further, the memory 106 may store instructions that, when executed by the one or more processors 104, may cause the one or more processors 104 to automate test case generation, in accordance with aspects of the present disclosure. The memory 106 may also store various data (for example, one or more requirements, one or more test cases, a plurality test steps, a set of test validation parameters, an output file, a processed output file, and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may further include a display 108. The system 100 may interact with a user interface 110 accessible via the display 108. The system 100 may also include one or more external devices 112. In some embodiments, the computing device 102 may interact with the one or more external devices 112 over a communication network 114 for sending or receiving various data. The communication network 114 may include, for example, but may not be limited to, a wireless fidelity (Wi-Fi) network, a light fidelity (Li-Fi) network, a local area network (LAN), a wide area network (WAN), a metropolitan area network (MAN), a satellite network, the internet, a fiber optic network, a coaxial cable network, an infrared (IR) network, a radio frequency (RF) network, and a combination thereof. The one or more external devices 112 may include, but may not be limited to, a remote server, a laptop, a netbook, a notebook, a smartphone, a mobile phone, a tablet, or any other computing device.

Referring now to FIG. 2, a functional block diagram 200 of various modules within a memory (such as the memory 106) of a computing device (102) configured for automated test case generation is illustrated, in accordance with some embodiments of the present disclosure. FIG. 2 is explained in conjunction with FIG. 1. The system 200 may be analogous to the system 100. The system 200 may implement the computing device 102. The memory 106 of the computing device 102 may include a generative Artificial Intelligence (AI) module 202 and an automation engine 204.

The generative AI module 202 may receive one or more requirements 206 in natural language from a user device. The one or more requirements 206 may be received in a text or a document format, such as Portable Document Format (PDF), Microsoft Excel Spreadsheet (XLSX), Microsoft Word Document (DOCX), or any other similar formats. Each of the one or more requirements 206 may contain information such as a unique requirement identity (ID), a requirement description, a remark, a pre-requisite, etc. The requirement ID may be a numeric value, an alphabetic character, a roman numeral, or an alpha-numeric value. It should be noted that each of the one or more requirements 206 may include an associated set of test scenarios. For example, the set of test scenarios may include, but may not be limited to, user login scenarios, data input scenarios, performance testing scenarios, and compatibility testing scenarios. In some embodiments, the set of test scenarios may include positive scenarios and negative scenarios.

The one or more requirements 206 may be obtained from a set of customer requirements corresponding to an Application Under Test (AUT). The set of customer requirements may be retrieved from an application database. The set of customer requirements may be, for example, but may not be limited to, functionality requirements, performance requirements, usability requirements, security requirements, maintainability requirements, user feedback requirements, and reliability requirements. It should be noted that each of the set of customer requirements and associated pre-requisites may be input one by one to the generative AI module 202 through an Application Programming Interface (API).

Further, the generative AI module 202 may extract the one or more requirements 206 from each of the set of customer requirements in a predefined pattern (i.e., a predefined format) through a preprocessing technique. The preprocessing technique may be selected based on the set of customer requirements. Further, the generative AI module 202 may assign the unique requirement ID (e.g. numeric value) to each of the one or more requirements 206. This may ensure that each of the one or more requirements 206 along with their unique requirement ID and supported information (or requirement description) are available for the processing.

Further, the generative AI module 202 may select a standalone Large Language Model (LLM) from one or more LLMs available in a data storage in the memory 106. As will be appreciated, a standalone LLM is preferable due to factors such as data sensitivity, information security factors, etc. The standalone LLM may be selecttest stepsed based on the one or more requirements 206, resource usage, and hardware availability. Further, the generative AI module 202 may fine-tune the standalone LLM using a fine-tuning dataset to obtain a standalone fine-tuned LLM 208.

In some embodiments, an LLM trained with large number of parameters may be selected to perform complex tasks (over an LLM trained with a smaller number of parameters). In some other embodiments, in text generation scenarios, a small or medium size LLM may give better result than a large size LLM. For example, an LLM of 7 B (trained with 7 billion parameters), 8 B (trained with 8 billion parameters), or 13 B (trained with 13 billion parameters) may be preferable than an LLM of 70 B (trained with 70 billion parameters). Hardware capacity of processor, Graphics Processing Unit (GPU), Random Access Memory (RAM), Hard Disk Drive (HDD), etc., may be determined based on LLM size, or vice versa. Environment to implement the computing device 102 may be set in a local premise or in a cloud setup with required processing capacity based on the on the selected standalone fine-tuned LLM 208.

Further, the generative AI module 202 may receive a configuration file 210 corresponding to the standalone fine-tuned LLM 208 via the API. It should be noted that the configuration file 210 may include a set of configuration parameters. By way of an example, the set of configuration parameters may include token limit, temperature, context setting, pre-requisites, number of test cases expected for each of the one or more requirements 206, and the like. Further, the generative AI module 202 may configure the standalone fine-tuned LLM 208 based on the set of configuration parameters to obtain a pre-configured LLM 212.

Once the pre-configured LLM 212 is obtained, the generative AI module 202 may generate one or more test cases 214 for each requirement of the one or more requirements 206 in a predefined template using the pre-configured LLM 212. The pre-defined template may be based on test automation framework requirements. It should be noted that each of the one or more test cases 214 may correspond to one of the associated set of test scenarios. It should also be noted that each of the one or more test cases 214 may include a plurality of test steps, test data corresponding to each of the plurality of test steps, and expected results of each of the plurality of test steps. In other words, the generative AI module 202 may generate the one or more test cases 214 with detailed plurality of test steps corresponding to each of the one or more requirements 206. It should be noted that, each of the plurality of test steps may include an action to be performed with at least one User Interface (UI) element. By way an example, in a test step ‘click on the login button’, ‘click’ may be an event, ‘login’ may be a text label, and ‘button’ may be the UI element.

Further, the generative AI module 202 may assign a unique test case ID to each of the one or more test cases 214. The unique test case ID may be a numeric value, an alphabetic character, a roman numeral, or an aplha-numeric value. Further, the generative AI module 202 may also assgin a unique test step ID to each of the plurality of test steps of each of the one or more test cases 214. The unique test step ID may be a numeric value, an alphabetic characters, a roman numerals, or an alpha-numeric value.

Upon generating the one or more test cases 214 for each requirement of the one or more requirements 206, the generative AI module 202 may perform a test case validation 216 on each of the one or more test cases 214 based on a set of test validation parameters. By way of an example, the set of test validation parameters may include test case functionality, test data, scenario coverage, and the like. For performing the test case validation 216, the generative AI module 202 may perform a check on each of the one or more test cases 214 to determine whether each of the plurality of test steps is completely defined. Further, the generative AI module 202 may validate a logical flow of the plurality of test steps for each of the one or more test cases 214.

Further, the generative AI module 202 may perform a check to determine whether one or more of the associated set of test scenarios implemented by the one or more test cases 214 is greater than or equal to a pre-defined threshold scenario coverage of the associated set of test scenarios. The check may ensure that a desired level of coverage of the set of test scenarios is achieved by the one or more test cases 214. In an embodiment, when the one or more of the associated set of test scenarios implemented by the one or more test cases 214 is less than the pre-defined threshold scenario coverage, then the generative AI module 202 may cause the preconfigured LLM 212 to generate more test cases to add to the one or more test cases 214 in order to increase total scenario coverage by the generated test cases. Alternatively, the generative AI module 202 may cause the preconfigured LLM 212 to generate at least one replacement test case to replace at least one of the one or more test cases 214. The at least one replacement test case may be designed to have a better scenario coverage than the test case that it may replace. This will increase the total scenario coverage by the one or more test cases 214.

When the test case validation 216 is successful, the generative AI module 202 may generate an output file 218 in a predefined format. By way of an example, the output file 218 may be a PDF document, a Word Document (DOC and DOCX), a Microsoft® excel spreadsheet (XLS and XLSX), Text File (TXT), and Comma separated Value (CSV). It should be noted that the output file 218 may include the one or more test cases 214. The output file 218 may include, for each of the one or more test cases 214, a test step number, plurality of test steps, test data corresponding to each of the plurality of test steps, and expected results of each of the plurality of test steps. The output file 218 may be converted into XLSX format (or any other file format) for easy review and maintenance. In a preferred embodiment, the output file 218 may be a workbook that may include a plurality of sheets (e.g., excel sheets). The one or more test cases 214 may be generated in a predefined template in the output file 218 to meet the test automation framework requirements and to overcome the test case development efforts.

By way of an example, each of the one or more test cases 214 along with the unique requirement ID may be generated in an excel workbook (i.e., the output file 218) where each of the plurality of sheets (e.g., excel sheets) may include one test case. In other words, each excel sheet may include one test case corresponding to the one or more requirements 206. This can be configured to get one test case per excel workbook or all generated into one workbook. In excel workbook the plurality of the sheets'name (e.g. file name of excel sheet) may be a combination of the unique requirement ID and the test case ID.

In an exemplary scenario, the generative AI module 202 may generate 2 test cases corresponding to a requirement ID ‘1’. Additionally, the generative AI module 202 may generate 3 test cases corresponding to a requirement ID ‘2’. In an embodiment, for a first test case and a second test case corresponding to the requirement ID ‘1’, the sheet names may be “req_1_tc_1” and “req_1_tc_2”, respectively. Here, ‘req_1’ stands for the requirement ID of the one or more requirements 206 and ‘tc_1’ and ‘tc_2’ stand for the test case ID of the one or more test cases 214. Similarly, for a first test case, a second test case, and a third test case corresponding to the requirement ID ‘2’, the sheet names may be “req_2_tc_1”, “req_2_tc_2”, and “req_2_tc_3”, respectively.

In some embodiments, if the generative AI module 202 may fail to generate the one or more test cases 214 corresponding to any of the one or more requirements 206, such requirements may be identified and may be passed through the generative AI module 202 once again to generate one or more corresponding test cases. This process may ensure that at least one test case is generated for each of the one or more requirements 206 and that there are no blanks or partial test cases in the output file 218.

Further, a user (e.g., a developer or tester) may perform a test case review 220 on the output file 218. Once the validation is completed, the generative AI module 202 may receive user feedback 216 corresponding to the output file 214. The output file 218 may be reviewed manually by a user based on the set of validation parameters. Alternatively, the test case review 220 for one or more of the set of validation parameters may be automated through use of automated quality gates. It should be noted that the user feedback in the test case review 220 may include scores corresponding to authenticity of content, the test data, and test flow. Further, the generative AI module 202 may perform reinforcement learning (RL) on the standalone fine-tuned LLM 208 by providing an RL feedback 222 based on the user feedback in the test case review 220. The standalone fine-tuned LLM 208 may learn from the scores provided by the user for each output file 218 for future reference.

Upon successful completion of the test case review 220, the output file 218 may be transmitted to the automation engine 204. The automation engine 204 may include a Machine Learning (ML) module 224 and an Execution module 226. Further, the ML module 224 may include a deep segment model 228. The deep segment model 228 may receive the output file 218.

For each of the one or more test cases 214 in the output file 218, the deep segment model 228 may segment one or more of the plurality of test steps based on a set of predefined rules to obtain an updated plurality of test steps. It should be noted that each of the one or more of the plurality of test steps may include complex sentences. The updated plurality of test steps may include segmented test steps obtained upon segmenting the one or more of the plurality of test steps as well as remaining of the plurality of test steps which were not segmented. By way of an example, the complex sentences may include compound statements, prepositions, conjunctions, conditional statements, repeated words, and the like. The complex sentences may include one or more phrases. The one or more phrases may include, for example, but may not be limited to, ‘from’, ‘and’, ‘under’, ‘in’, ‘after’, and ‘before’. It should be noted that segmentation of a test step via the deep segment model 228 may be performed only when the test step may include at least one complex phrase.

Further, the deep segment model 228 may arrange the updated plurality of test steps in an order of precedence to obtain a valid test step flow.

Further, the deep segment model 228 may transmit the updated plurality of test steps to a Named Entity Recognition (NER) model 230. For each test step of the updated plurality of test steps, the NER model 230 may classify each of phrases in the test step into a set of tags. The NER model 230 may be trained with a dataset to classify each of the phrases in the test steps into the set of tags. By way of an example, the set of tags may include, but may not be limited to, the unique test case ID, the unique test step ID, control, control text, event, the test data, and the expected results. The NER model 230 may generate a processed output file 232 for each of the one or more test cases. The processed output file 232 may include the phrases in the test steps categorized into the set of tags in a predefined template (e.g., control, control text, event, test data, and expected results).

Upon classification of the phrases by the NER model 230, there may still be phrases in the updated plurality of test steps that are unsuccessfully classified by the NER model 230. Further, for each test step of the updated plurality of test steps, an Associated Rule-Based Learning (ARL) model 234 may additionally process the processed output file 232. The ARL model 234 may classify unclassified phrases (i.e., the phrases that are unsuccessfully classified by the NER model 230) in the test step into the set of tags. There may be cases where the ‘event’ and ‘control’ may not be classified by the NER model 230. By way of an example, consider the phrase “click login”. In this phrase “click” may be the ‘event’ and “login” may be the ‘control text’ and “control” phrase may be left blank. To overcome this scenario, the ARL model 234 may fill the blank phrase (e.g., ‘control’ or ‘event’) with appropriate ‘controls’or ‘events’for seamlessly processing. There may be an automated internal validation process to ensure each test step may contain appropriate phrases (e.g., ‘event’ and ‘control’) that may be taken care of through standardization 234.

Further, the ML module 224 may transmit the processed output file 232 to the execution module 226 in the predefined template for further processing. The execution module 226 may perform an AUT scan 236 on the AUT. Through the AUT scan 236, the execution module 226 may identify dynamic elements in the AUT. Further, the execution module 226 may update the processed output file 232 with the dynamic elements. The execution module 226 may then perform test step processing 238 for each of the plurality of test steps. The dynamic elements may be updated in the processed output file 232 to execute each of the plurality of test steps one by one on the AUT. The phrase ‘events’in the processed output file 232 may be performed on the AUT. Reports and evidence 240 may be collected for each of the plurality of test steps. The reports and evidence 240 may be validated with the expected results and the results may be updated as ‘Pass’or ‘Fail’ (or successful or unsuccessful) for each of the plurality of test steps. The execution module 226 may render reports through a historical dashboard 242 on the user device. The results along with the reports and evidence 240 that may be collected for each test step may be available in the rendered reports for user reference.

It should be noted that all such aforementioned modules 202-238 may be represented as a single module or a combination of different modules. Further, as will be appreciated by those skilled in the art, each of the modules 202-204 may reside, in whole or in parts, on one device or multiple devices in communication with each other. In some embodiments, each of the modules 202-204 may be implemented as dedicated hardware circuit comprising custom application-specific integrated circuit (ASIC) or gate arrays, off-the-shelf semiconductors such as logic chips, transistors, or other discrete components. Each of the modules 202-204 may also be implemented in a programmable hardware device such as a field programmable gate array (FPGA), programmable array logic, programmable logic device, and so forth. Alternatively, each of the modules 202-204 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for automated test case generation. For example, the exemplary system 100 and the associated computing device 102, 200 may automate test case generation by the processes discussed herein. In particular, as will be appreciated by those of ordinary skill in the art, control logic and/or automated routines for performing the techniques and steps described herein may be implemented by the system 100 and the associated computing device 102, 200 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

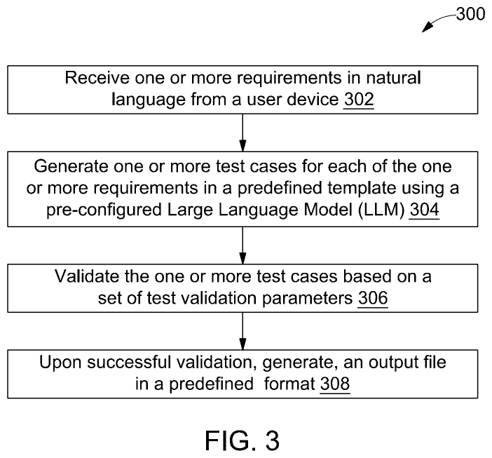

Referring now to FIG. 3, an exemplary process 300 for automated test case generation is illustrated via a flow chart, in accordance with some embodiments of the present disclosure. The process 300 may be implemented by the computing device 102 of the system 100. In some embodiments, the process 300 may include retrieving, by the generative AI module 202, a set of customer requirements corresponding to an Application Under Test (AUT). Further, the process 300 may include extracting, by the generative AI module 202, one or more requirements from each of the set of customer requirements in a predefined pattern. The process 300 may include receiving, by the generative AI module 202, the one or more requirements (such as the one or more requirements 206) in natural language from a user device, at step 302. It should be noted that each of the one or more requirements may include an associated set of test scenarios. Further, the process 300 may include assigning, by the generative AI module 202, a unique requirement ID (e.g., numerical value) to each of the one or more requirements.

In some embodiments, the process 300 may include selecting, by the generative AI module 202, an LLM based on the one or more requirements, resource usage, and hardware availability. Further, the selected LLM may be downloaded to the computing device 102. The selected LLM may be referred to as a standalone LLM. Further, the process 300 may include fine-tuning, by the generative AI module 202, the standalone LLM using a fine-tuning dataset and domain-specific parameters to obtain a standalone fine-tuned LLM (such as the standalone fine-tuned LLM 208). The fine-tuning dataset may include domain-specific data. The fine-tuning may enrich the LLM with domain-specific aspects to ensure the responses generated by the LLM are more specific to the domain.

Additionally, the process may include receiving, by the generative AI module 202, a configuration file (such as the configuration file 210) corresponding to the fine-tuned standalone LLM via an API. The configuration file may include a set of configuration parameters. The set of configuration parameters may include token limit, temperature, context setting, pre-requisites, number of test cases expected for each of the one or more requirements, and the like. The set of configuration parameters may be used to instruct the standalone fine-tuned LLM 208 to get a desired output for each time a requirement is passed. In other words, the set of configuration parameters corresponds to LLM instructions to obtain an optimal output for a user input requirement. Further, the process 300 may include configuring, by the generative AI module 202, the fine-tuned standalone LLM based on the set of configuration parameters to obtain a preconfigured LLM (such as the preconfigured LLM 212).

Further, the process 300 may include generating, by the generative AI module 202, one or more test cases for each requirement of the one or more requirements in a pre-defined template using the pre-configured LLM, at step 304. Each of the one or more test cases implements one of the associated set of test scenarios. Each of the one or more test cases may include a plurality of test steps, test data corresponding to each of the plurality of test steps, and expected results of each of the plurality of test steps.

Further, the process 300 may include assigning, by the generative AI module 202, a unique test case ID to each of the one or more test cases. Further, the process 300 may include assigning, by the generative AI module 202, a unique test step ID to each of the plurality of test steps of each of the one or more test cases.

Further, the process 300 may include validating, by the generative AI module 202, the one or more test cases based on a set of test validation parameters, at step 306. By way of an example, the set of test validation parameters may include test case functionality, test data, scenario coverage, and the like. Further, the step 306 of the process 300 may include performing, by the generative AI module 202, a check on each on each of the one or more test cases to determine whether each of the plurality of test steps is completely defined. Further, the step 306 of the process 300 may include validating, by the generative AI module 202, a logical flow of the plurality of test steps for each of the one or more test cases. Further, the step 306 of the process 300 may include performing, by the generative AI module 202, a check to determine whether one or more of the associated set of test scenarios implemented by the one or more test cases is greater than or equal to a pre-defined threshold scenario coverage of the associated set of test scenarios. In an embodiment, the set of validation parameters may be defined in the configuration file.

Further, upon successful validation, the process 300 may include generating, by the generative AI module 202, an output file (such as the output file 218) in a pre-defined format. The output file may include the one or more test cases (such as the one or more test cases 214). In some embodiments, if the generative AI module 202 fails to generate output for any one or more requirements that may be identified and may be passed to the generative AI module 202 once again for generated test cases. This process may ensure one or more test cases may be generated for each of the one or more requirements and there may be no blanks or partial test cases in the output file.

Further, the process 300 may include receiving, by the generative AI module 202, user feedback corresponding to the output file. The user feedback may include scores corresponding to authenticity of content, the test data, and the test flow. Further, the process 300 may include performing, by the generative AI module 202, RL on the pre-configured LLM based on the user feedback (such as the RL feedback 222).

Further, the process 300 may include transmitting, by the generative AI module 202, the output file to a deep segment model (such as the deep segment model 228). For each of the one or more test cases, the process 300 may include segmenting, by the ML module 224, one or more of the plurality of test steps using the deep segment model based on a set of pre-defined rules to obtain an updated plurality of test steps. It should be noted that each of the one or more of the plurality of test steps may include complex sentences. For remaining of the plurality of test steps (i.e., test steps that do not include complex sentences), segmentation may not be performed. Thus, the updated plurality of test steps may include segmented test steps obtained upon segmenting the one or more of the plurality of test steps, as well as remaining of the plurality of test steps which were not segmented. Further, the process 300 may include arranging, by the ML module 224, the updated plurality of test steps in an order of precedence to obtain a valid test step flow using the deep segment model.

Further, the process 300 may include transmitting, by the ML module 224, the updated plurality of test steps to an NER model (such as the NER model 230). For each test step of the updated plurality of test steps, the process 300 may include classifying, by the ML module 224, each of phrases in the test step into a set of tags using the NER model. Further, for each test step of the updated plurality of test steps, the process 300 may include classifying, by the ML module 224, unclassified phrases in the test step into the set of tags using an ARL model (such as the ARL model 234). Further, the process 300 may include generating, by the ML module 220, a processed output file (such as the processed output file 232) in pre-defined template. The processed output file may include the phrases in the test steps classified into the set of tags. Further, the process 300 may include transmitting, by the ML module 224, the processed output file to the execution module 226 for further processing.

Further, the process 300 may include scanning, by the execution module 226, the AUT using the processed output file to identify a dynamic element for each of the plurality of test steps. Further, the process 300 may include processing, by the execution module 226, the dynamic elements in the processed output file to execute the each of the plurality of test steps one by one on the AUT. Further, the process 300 may include rendering, by the execution module 226, a report and a historical dashboard (such as the reports and historical dashboard 242) on the user device along with the evidence for each of the one or more plurality of test cases.

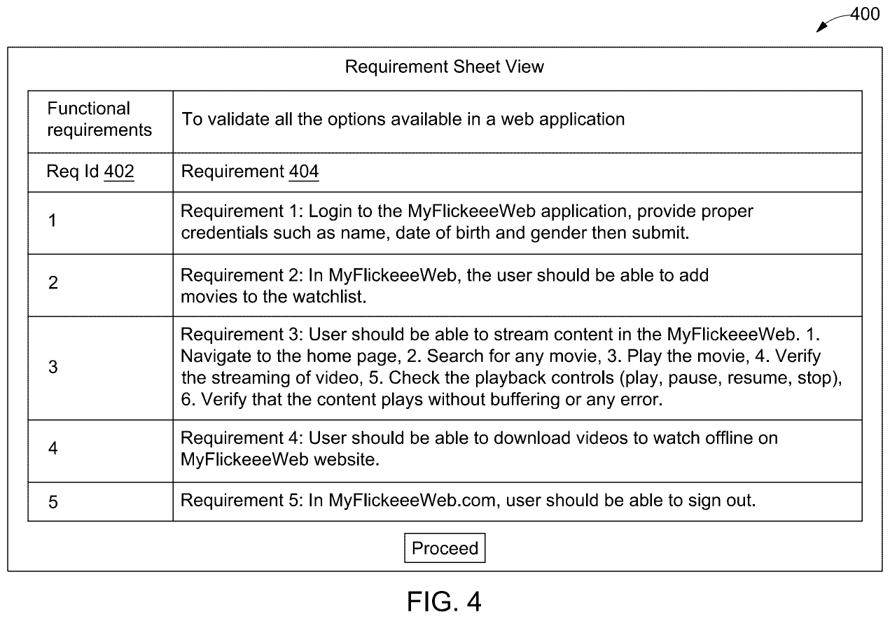

Referring now to FIG. 4, an exemplary requirement sheet 400 is illustrated, in accordance with some embodiments of the present disclosure. The requirement sheet 400 may include one or more requirements (such as the one or more requirements 206). The requirement sheet 400 is presented in a tabular format. The generative AI module 202 may receive the one or more requirements 206 in the natural language (for example, English language) from the user device. Each of the one or more requirements may include the associated set of test scenarios. The requirement sheet 400 may include a column for unique requirement ID (req ID) 402 of the one or more requirements 206 and a column for requirement 404.

For example, for the requirement ID 402 ‘1’, the requirement 404 may be ‘Login to the MyFlickeeeWeb application, provide proper credentials such as name, date of birth, and gender then submit’. For the requirement ID 402 ‘2’, the requirement 404 may be ‘In MyFlickeeeWeb, the user should be able to add movies to the watchlist’. The requirement 404 may be ‘User should be able to stream content in the MyFlickeeeWeb. (i.e. step 1: Navigate to the home page, step 2: Search for any movie, step 3: Play the movie, step 4: Verify the streaming of video, step 5: Check the playback controls (e.g. play, pause, resume, stop), and step 6: Verify that the content plays without buffering or any other error’ and the requirement ID 402 for the requirement 404 may be ‘3’. The requirement 404 may be ‘User should be able to download videos to watch offline on MyFlickeeeWeb website’ and the requirement ID 402 for the requirement 404 may be ‘4’. The requirement 404 may be ‘In MyFlickeeeWeb.com, user should be able to sign out’ and the requirement ID 402 for the requirement 404 may be ‘5’.

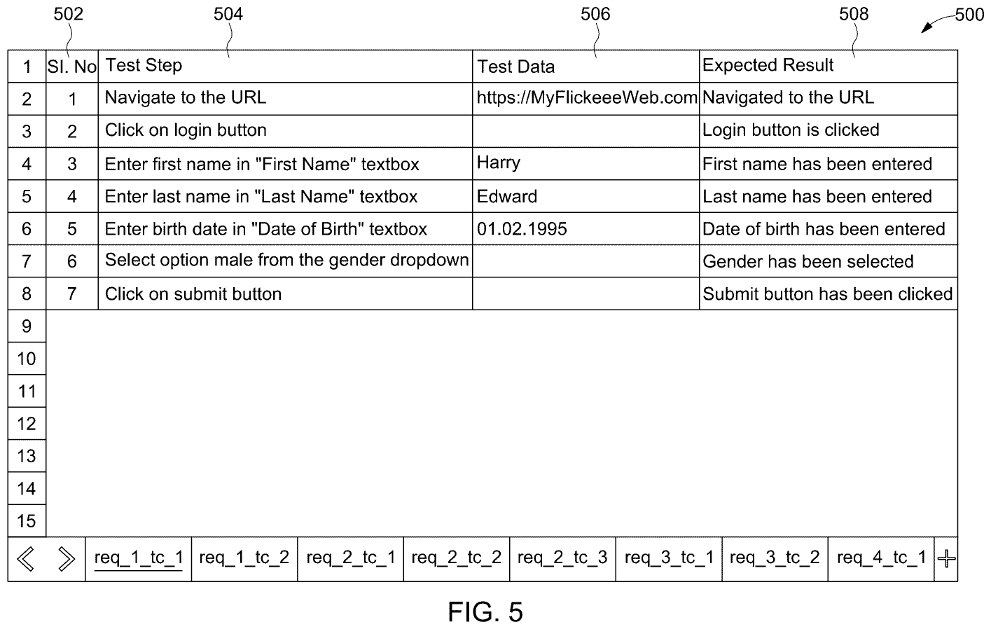

Referring now to FIG. 5, an exemplary output file 500 is illustrated, in accordance with some embodiments of the present disclosure. FIG. 5 is explained in conjunction with FIG. 4. The output file 500 may be analogous to the output file 214. The output file 500 is presented in a tabular format. The output file 500 may include a column for test step no. 502, a column for plurality of test steps 504 for the requirement ID 402 ‘1’, a column for test data 506 corresponding to each of the plurality of test steps, and a column for expected result 508 of each of the plurality of test steps.

Further, the generative AI module 202 may generate the one or more test cases for each requirement ID 402 (e.g. ‘1’, ‘2’, ‘3’, ‘4’, and ‘5’) in the predefined template using the pre-configured LLM 208. Each of the one or more test cases may include the plurality of test steps, test data corresponding to each of the plurality of test steps, and the expected results of each of the plurality of test steps. In continuation with the above example, a test case may be generated for the requirement ID 402 ‘1’ (e.g. ‘Login to the MyFlickeeeWeb application, provide proper credentials such as name, date of birth, and gender then submit’) may include the plurality of test steps, test data corresponding to each of the plurality of test steps, and expected results of each of the plurality of test steps. In some embodiments, generative AI module 202 may generate more than one test case for the requirement ID 402 ‘1’. Once the test case is generated for the requirement ID 402 ‘1’, the generative AI module 202 may validate the generated test case based on the set of test validation parameters.

Further, the generative AI module 202 may generate the output file 500 for the requirement ID 402 ‘1’. The output file 500 includes one excel sheet for the test case ‘1’. The file name of the excel sheet may be ‘req_1_tc_1’. In continuation with the above example, following are some exemplary plurality of test steps, test data, and expected results for the test case ‘1’ of the requirement ID 402 ‘1’.

For a test step no. 502 ‘1’, the test step 504 may be ‘Navigate to the URL’, the test data 506 may be ‘https://MyFlickeeeWeb.com’, and the expected result 508 may be ‘Navigated to the URL’.

For a test step no. 502 ‘2’, the test step 504 may be ‘Click on Login button’, the test data 506 may be blank, and the expected result 508 may be ‘Login button is clicked’.

For a test step no. 502 ‘3’, the test step 504 may be ‘Enter first name in “First Name” textbox’, the test data 506 may be ‘Harry’, and the expected result 508 may be ‘First name has been entered’.

For a test step no. 502 ‘4’, the test step 504 may be ‘Enter last name in “Last Name” textbox’, the test data 506 may be ‘Edward, and the expected result 508 may be ‘Last name has been entered’.

For a test step no. 502 ‘5’, the test step 504 may be ‘Enter birth date in “Date of birth” textbox, the test data 506 may be ‘01.02.1995’, and the expected result 508 may be ‘Date of birth has been entered’.

For a test step no. 502 ‘6’, the test step 504 may be ‘Select option Male from the Gender dropdown’, the test data 506 may be blank, and the expected result 508 may be ‘Gender has been selected’.

For a test step no. 502 ‘7’, the test step 504 may be ‘Click on Submit button’, the test data 506 may be blank, and the expected result 508 may be ‘Submit button has been clicked’.

It should be noted that the test data corresponding to the test steps may be changed by the tester during the stage of review as per their need. In continuation with the above example, the tester may change the test data ‘Harry’ at the stage of review.

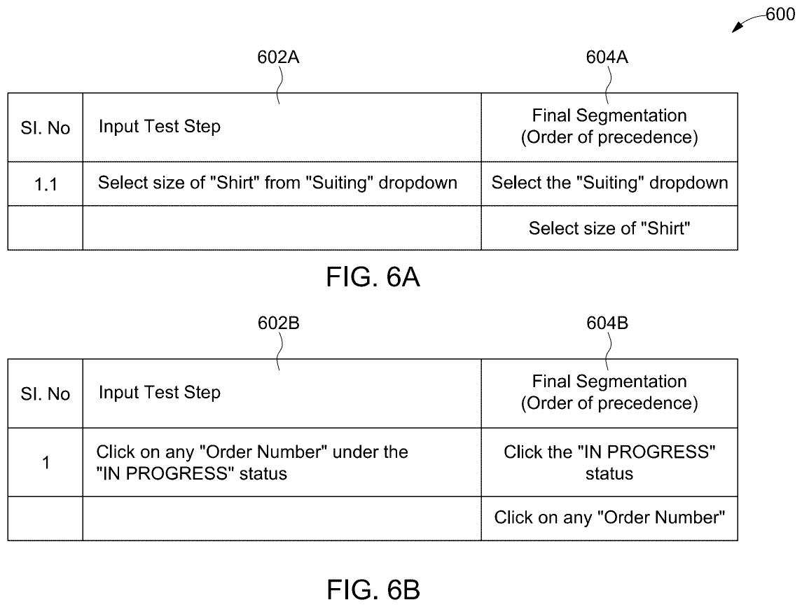

Referring now to FIG. 6A, an exemplary table 600A representing segmented test steps is illustrated, in accordance with some embodiments of the present disclosure. The table 600A is presented in a tabular format. The table 600A may include a column for test step 602A and a column for segmented test steps 604A to obtain valid test step flow. Once the output file 500 is reviewed by the tester, the generative AI module 202 may transmit the output file 500 to the deep segment model 224. By way of an example, the test step 602A may be ‘Select size of “Shirt” from “Suiting” dropdown’. Further, the deep segment model 224 may detect complex phrases (e.g. ‘from’) from the test step 602A. Further, the deep segment model 224 may segment the test step 602A based on the complex phrase. The segmented test step 604A may be ‘Select size of “Shirt”’ and ‘Select the “Suiting” dropdown’. The segmented test steps 604A may be included along with non-complex test steps (i.e., test steps with simple sentences for which segmentation was not performed) in an updated plurality of test steps. Further, the deep segment model 224 may arrange the segmented test steps 604A in the order of precedence. Thus, the updated plurality of test steps may be in a valid test step flow after the arranging.

Referring now to FIG. 6B, another exemplary table 600B is illustrated, in accordance with some embodiments of the present disclosure. FIG. 6B is explained in conjunction with FIG. 6A. By way of an example, the test step 602B may be ‘Click on any “Order Number” under the “IN PROGRESS” status’. Further, the deep segment model 224 may detect complex phrases (e.g. ‘under’) from the test step 602B. Further, the deep segment model 224 may segment the test step 602 based on the complex phrase (e.g. ‘under’). The segmented test steps 604B may be ‘Click the “IN PROGRESS” status’and ‘Click on any “Order Number”’. Further, the deep segment model 224 may arrange the segmented test step 604B in the order of precedence to obtain valid test step flow.

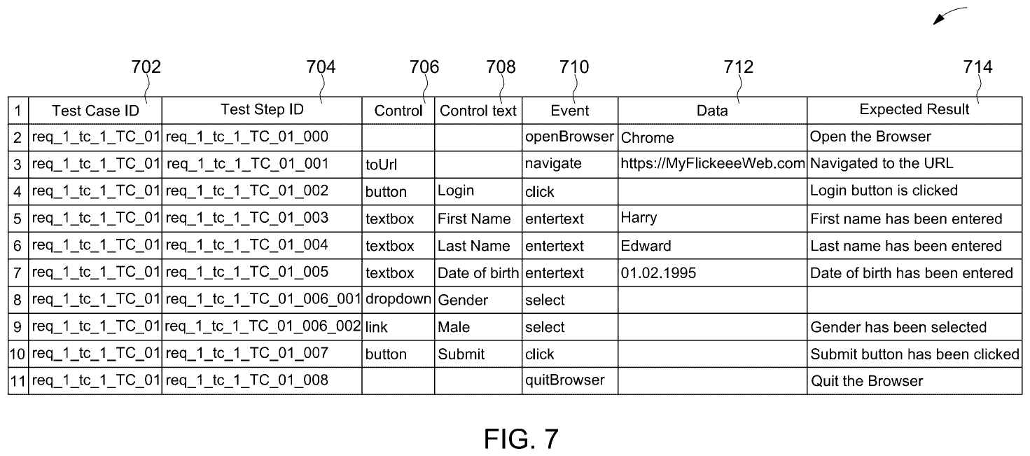

Referring now to FIG. 7, an exemplary processed output file 700 is illustrated, in accordance with some embodiments of the present disclosure. FIG. 7 is explained with the conjunction of FIG. 4-6A-B. In an embodiment, the processed output file 700 may be analogous to the processed output file 232. The processed output file 700 is presented in a tabular format. The processed output file 700 may include a column for test case ID 702, a column for test step ID 704, a column for control 706, a column for control text 708, a column for event 710, a column of test data 712 (analogous to the test data 506), and a column for expected results 714 (analogous to the expected result 508).

Once the test steps are segmented, the deep segment model 224 may transmit the output file 500 (including the updated plurality of test steps) to the NER model 226 to classify each of phrases in the test step (i.e., each test step of the updated plurality of test steps) into the set of tags. There are chances where an “event” or “control” may not be classified by the NER model 226. To overcome these scenarios the ARL model 228 may fill the blanks with appropriate “controls” or “events” for seamless processing. Further, the NER model 226 may generate the processed output file 700.

In continuation with the above example, each of the plurality of test steps, control, control text, event, test data, and expected result may be generated for the test case ID 702 ‘req_1_tc_1_TC_01’ of the requirement ID 402 ‘1’.

For the test step no. ‘0’, the test step ID 704 may be ‘req_1_tc_1_TC_01_000’, the control 706 may be blank, the control text 708 may be blank, the event 710 may be ‘Open Browser’, the test data 712 may be ‘Chrome’, and the expected result 714 may be ‘Open the Browser’.

For the test step no. 502 ‘1’, the test step ID 704 may be ‘req_1_tc_1_TC_01_001’, the control 706 may be ‘to URL’, the control text 708 may be blank, the event 710 may be ‘Navigate’, the test data 712 may be ‘http://MyFlickeeeWeb.com’, and the expected result 714 may be ‘Navigated to the URL’.

For the test step no. 502 ‘2’, the test step ID 704 may be ‘req_1_tc_1_TC_01_002’, the control 706 may be ‘Button’, the control text 708 may be ‘Login’, the event 710 may be ‘Click’, the test data 712 may be blank, and the expected result may be ‘Login button is clicked’.

For the test step no. 502 ‘3’, the test step ID 704 may be ‘req_1_tc_1_TC_01_003’, the control 706 may be ‘Textbox’, the control text 708 may be ‘First Name’, the event 710 may be ‘Enter Text’, the test data 712 may be ‘Harry’, and the expected result may be ‘First Name has been entered’.

For the test step no. 502 ‘4’, the test step ID 704 may be ‘req_1_tc_1_TC_01_004’, the control 706 may be ‘Textbox’, the control text 708 may be ‘Last Name’, the event 710 may be ‘Enter Text’, the test data 712 may be ‘Edward’, and the expected result may be ‘Last Name has been entered’.

For the test step no. 502 ‘5’, the test step ID 704 may be ‘req_1_tc_1_TC_01_005’, the control 706 may be ‘Textbox’, the control text 708 may be ‘Date of Birth’, the event 710 may be ‘Enter Text’, the test data 712 may be ‘01.02.1995’, and the expected result may be ‘Date of Birth has been entered’.

For the test step no. 520 ‘6’, the test step ID 704 may be ‘req_1_tc_1_TC_01_006_001’, the control 706 may be ‘Dropdown’, the control text 708 may be ‘Gender’, the event 710 may be ‘Select’, the test data 712 may be blank, and the expected result may be blank.

For the test step no. 502 ‘6’, the test step ID 704 may be ‘req_1_tc_1_TC_01_006_002’, the control 706 may be ‘Link’, the control text 708 may be ‘Male’, the event 710 may be ‘Select’, the test data 712 may be blank, and the expected result may be ‘Gender has been selected’. It should be noted that the test step number 520 ‘6’ may be segmented into test steps with test step IDs ‘req_1_tc_1_TC_01_006_001’ and ‘req_1_tc_1_TC_01_006_002’. The segmented test step may be arranged in the table 700 in the order of precedence.

For the test step no. 502 ‘7’, the test step ID 704 may be ‘req_1_tc_1_TC_01_007’, the control 706 may be ‘Button’, the control text 708 may be ‘Submit’, the event 710 may be ‘Click’, the test data 712 may be blank, and the expected result may be ‘Submit button has been clicked’.

For the test step no. ‘8’, the test step ID 704 may be ‘req_1_tc_1_TC_01_008’, the control 706 may be blank, the control text 708 may be blank, the event 710 may be ‘Quit Browser’, the test data 712 may be blank, and the expected result may be ‘Quit the Browser’.

Once the processed output file 700 is generated, the execution module 226 may scan the AUT using the processed output file 700 to identify the dynamic element. Further, the dynamic elements are updated in the processed output file 700 to execute the test steps one by one on the AUT. The events in the processed output file 700 may be performed on the application and evidence may be collected for each test step of the test case ‘1’. This evidence may be validated with expected results and the results may be updated as Pass or Fail for each test step of the test case ‘1’. Further, the execution module 226 may render the report and the historical dashboard on the user device for future reference.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

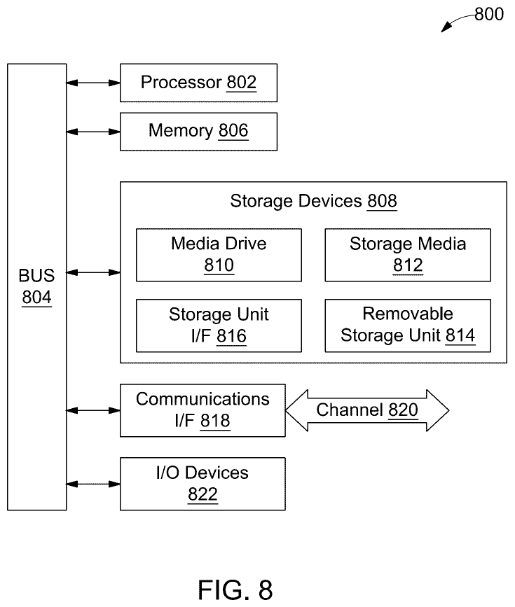

The disclosed methods and systems may be implemented on a conventional or a general-purpose computer system, such as a personal computer (PC) or server computer. Referring now to FIG. 8, an exemplary computing system 800 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 800 may represent, for example, a user device such as a desktop, a laptop, a mobile phone, personal entertainment device, DVR, and so on, or any other type of special or general-purpose computing device as may be desirable or appropriate for a given application or environment. The computing system 800 may include one or more processors, such as a processor 802 that may be implemented using a general or special purpose processing engine such as, for example, a microprocessor, microcontroller or other control logic. In this example, the processor 802 is connected to a bus 804 or other communication medium. In some embodiments, the processor 802 may be an Artificial Intelligence (AI) processor, which may be implemented as a Tensor Processing Unit (TPU), or a graphical processor unit, or a custom programmable solution Field-Programmable Gate Array (FPGA).

The computing system 800 may also include a memory 806 (main memory), for example, Random Access Memory (RAM) or other dynamic memory, for storing information and instructions to be executed by the processor 802. The memory 806 also may be used for storing temporary variables or other intermediate information during execution of instructions to be executed by the processor 802. The computing system 800 may likewise include a read only memory (“ROM”) or other static storage device coupled to bus 804 for storing static information and instructions for the processor 802.

The computing system 800 may also include a storage devices 808, which may include, for example, a media drive 810 and a removable storage interface. The media drive 810 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 812 may include, for example, a hard disk, magnetic tape, flash drive, or other fixed or removable medium that is read by and written to by the media drive 810. As these examples illustrate, the storage media 812 may include a computer-readable storage medium having stored therein particular computer software or data.

In alternative embodiments, the storage devices 808 may include other similar instrumentalities for allowing computer programs or other instructions or data to be loaded into the computing system 800. Such instrumentalities may include, for example, a removable storage unit 814 and a storage unit interface 816, such as a program cartridge and cartridge interface, a removable memory (for example, a flash memory or other removable memory module) and memory slot, and other removable storage units and interfaces that allow software and data to be transferred from the removable storage unit 814 to the computing system 800.

The computing system 800 may also include a communications interface 818. The communications interface 818 may be used to allow software and data to be transferred between the computing system 800 and external devices. Examples of the communications interface 818 may include a network interface (such as an Ethernet or other NIC card), a communications port (such as for example, a USB port, a micro USB port), Near field Communication (NFC), etc. Software and data transferred via the communications interface 818 are in the form of signals which may be electronic, electromagnetic, optical, or other signals capable of being received by the communications interface 818. These signals are provided to the communications interface 818 via a channel 820. The channel 820 may carry signals and may be implemented using a wireless medium, wire or cable, fiber optics, or other communications medium. Some examples of the channel 820 may include a phone line, a cellular phone link, an RF link, a Bluetooth link, a network interface, a local or wide area network, and other communications channels.

The computing system 800 may further include Input/Output (I/O) devices 822. Examples may include, but are not limited to a display, keypad, microphone, audio speakers, vibrating motor, LED lights, etc. The I/O devices 822 may receive input from a user and also display an output of the computation performed by the processor 802. In this document, the terms “computer program product” and “computer-readable medium” may be used generally to refer to media such as, for example, the memory 806, the storage devices 808, the removable storage unit 814, or signal(s) on the channel 820. These and other forms of computer-readable media may be involved in providing one or more sequences of one or more instructions to the processor 802 for execution. Such instructions, generally referred to as “computer program code” (which may be grouped in the form of computer programs or other groupings), when executed, enable the computing system 800 to perform features or functions of embodiments of the present invention.

In an embodiment where the elements are implemented using software, the software may be stored in a computer-readable medium and loaded into the computing system 800 using, for example, the removable storage unit 814, the media drive 810 or the communications interface 818. The control logic (in this example, software instructions or computer program code), when executed by the processor 802, causes the processor 802 to perform the functions of the invention as described herein.

Various embodiments provide method and system for automated test case generation. The disclosed method and system may receive one or more requirements in natural language from a user device. Each of the one or more requirements may include an associated set of test scenarios. Further, the disclosed method and system may generate one or more test cases for each requirement of the one or more requirements in a predefined template using a pre-configured Large Language Model (LLM). Each of the one or more test cases implements one of the associated set of test scenarios. Each of the one or more test cases may include a plurality of test steps, test data corresponding to each of the plurality of test steps, and expected results of each of the plurality of test steps. Moreover, the disclosed method and system may validate the one or more test cases based on a set of test validation parameters. The set of test validation parameters may include test case functionality, test data, and scenario coverage. Thereafter, upon successful validation the disclosed method and system may generate an output file in a predefined format. The output file may include the one or more test cases.

Thus, the disclosed method and system try to overcome the technical problem of automated test case generation. The method and system may automate the entire testing phase from test requirements to test case execution without generating any code in background. The method and system may reduce the manual efforts by up to 70%. The method and system provide evidence for each of the test cases in the report dashboard for future reference. The method and system may increase the scenarios (or test) coverage and efficiency of the testing teams, software developers, etc. In addition, the method and system may reduce the dependency on skilled programmers to work on automation area. The method and system may help the testers to automate the entire testing phase from test requirements to the test case execution without having any coding skills. The method and system may also be applicable to Software Development Life Testing (SDLT) phase such as, requirement analysis, build, development, testing, and reporting. The method and system may select an optimal LLM which enables the user to plan the hardware cost involved in loading, processing and training of the LLM.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for automated test case generation. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for automated test case generation, the method comprising:
receiving, by a computing device, one or more requirements in natural language from a user device, wherein each of the one or more requirements comprises an associated set of test scenarios;
generating, by the computing device, one or more test cases for each requirement of the one or more requirements in a predefined template using a pre-configured Large Language Model (LLM), wherein each of the one or more test cases implements one of the associated set of test scenarios, and wherein each of the one or more test cases comprises a plurality of test steps, test data corresponding to each of the plurality of test steps, and expected results of each of the plurality of test steps;
validating, by the computing device, the one or more test cases based on a set of test validation parameters, wherein the set of test validation parameters comprises test case functionality, test data, and scenario coverage; and
upon successful validation, generating, by the computing device, an output file in a predefined format, wherein the output file comprises the one or more test cases.

2. The method of claim 1, further comprising:
retrieving a set of customer requirements corresponding to an Application Under Test (AUT); and
extracting the one or more requirements from each of the set of customer requirements in a predefined pattern.

3. The method of claim 1, further comprising assigning a unique requirement ID to each of the one or more requirements.

4. The method of claim 1, further comprising:
selecting an LLM based on the one or more requirements, resource usage, and hardware availability; and
fine-tuning the LLM using a fine-tuning dataset and domain-specific parameters to obtain a fine-tuned LLM, wherein the fine-tuning dataset comprises domain-specific data.

5. The method of claim 4, further comprising:
receiving a configuration file corresponding to the fine-tuned LLM via an Application Programming Interface (API), wherein the configuration file comprises a set of LLM configuration parameters, wherein the set of configuration parameters comprises token limit, temperature, context setting, pre-requisites, and number of test cases expected for each of the one or more requirements, and wherein the set of configuration parameters corresponds to LLM instructions to obtain an optimal output for an input requirement; and
configuring the fine-tuned LLM based on the set of configuration parameters to obtain the pre-configured LLM.

6. The method of claim 1, further comprising:
assigning a unique test case ID to each of the one or more test cases; and
assigning a unique test step ID to each of the plurality of test steps of each of the one or more test cases.

7. The method of claim 1, wherein validating the one or more test cases comprises:
performing, by the computing device, a check on each of the one or more test cases to determine whether each of the plurality of test steps is completely defined;
validating, by the computing device, a logical flow of the plurality of test steps for each of the one or more test cases; and
performing, by the computing device, a check to determine whether one or more of the associated set of test scenarios implemented by the one or more test cases is greater than or equal to a predefined threshold scenario coverage of the associated set of test scenarios.

8. The method of claim 1, further comprising:
receiving user feedback corresponding to the output file, wherein the user feedback comprises scores corresponding to authenticity of content, the test data, and test flow; and
performing reinforcement learning (RL) on the pre-configured LLM based on the user feedback.

9. The method of claim 1, further comprising:
transmitting the output file to a deep segment model;
for each of the one or more test cases, segmenting one or more of the plurality of test steps using the deep segment model based on a set of predefined rules to obtain an updated plurality of test steps, wherein each of the one or more of the plurality of test steps comprises complex sentences, and wherein the updated plurality of test steps comprises:
segmented test steps obtained upon segmenting the one or more of the plurality of test steps, and
remaining of the plurality of test steps; and
arranging the updated plurality of test steps in an order of precedence to obtain a valid test step flow.

10. The method of claim 9, further comprising:
transmitting the updated plurality of test steps to a Named Entity Recognition (NER) model;
for each test step of the updated plurality of test steps, classifying each of phrases in the test step into a set of tags using the NER model; and
for each test step of the updated plurality of test steps, classifying unclassified phrases in the test step into the set of tags using an Associated Rule-Based Learning (ARL) model, wherein the unclassified phrases are phrases that are unsuccessfully classified by the NER model.

11. A system for automated test case generation, the system comprising:
a processor; and
a memory communicatively coupled to the processor, wherein the memory stores processor instructions, which when executed by the processor, cause the processor to:
receive one or more requirements in natural language from a user device, wherein each of the one or more requirements comprises an associated set of test scenarios;
generate one or more test cases for each requirement of the one or more requirements in a predefined template using a pre-configured Large Language Model (LLM), wherein each of the one or more test cases implements one of the associated set of test scenarios, and wherein each of the one or more test cases comprises a plurality of test steps, test data corresponding to each of the plurality of test steps, and expected results of each of the plurality of test steps;
validate the one or more test cases based on a set of test validation parameters, wherein the set of test validation parameters comprises test case functionality, test data, and scenario coverage; and
upon successful validation, generate an output file in a predefined format, wherein the output file comprises the one or more test cases.

12. The system of claim 11, wherein the processor instructions, on execution, further cause the processor to:
retrieve a set of customer requirements corresponding to an Application Under Test (AUT); and
extract the one or more requirements from each of the set of customer requirements in a predefined pattern.

13. The system of claim 11, wherein the processor instructions, on execution, further cause the processor to assign a unique requirement ID to each of the one or more requirements.

14. The system of claim 11, wherein the processor instructions, on execution, further cause the processor to:
select an LLM based on the one or more requirements, resource usage, and hardware availability; and
fine-tune the LLM using a fine-tuning dataset and domain-specific parameters to obtain a fine-tuned LLM, wherein the fine-tuning dataset comprises domain-specific data.

15. The system of claim 14, wherein the processor instructions, on execution, further cause the processor to:
receive a configuration file corresponding to the fine-tuned LLM via an Application Programming Interface (API), wherein the configuration file comprises a set of LLM configuration parameters, wherein the set of configuration parameters comprises token limit, temperature, context setting, pre-requisites, and number of test cases expected for each of the one or more requirements, and wherein the set of configuration parameters corresponds to LLM instructions to obtain an optimal output for an input requirement; and
configure the fine-tuned LLM based on the set of configuration parameters to obtain the pre-configured LLM.

16. The system of claim 11, wherein the processor instructions, on execution, further cause the processor to:
assign a unique test case ID to each of the one or more test cases; and
assign a unique test step ID to each of the plurality of test steps of each of the one or more test cases.

17. The system of claim 11, wherein to validate the one or more test cases, the processor instructions, on execution, cause the processor to:
perform a check on each of the one or more test cases to determine whether each of the plurality of test steps is completely defined;
validate a logical flow of the plurality of test steps for each of the one or more test cases; and
perform a check to determine whether one or more of the associated set of test scenarios implemented by the one or more test cases is greater than or equal to a predefined threshold scenario coverage of the associated set of test scenarios.

18. The system of claim 11, wherein the processor instructions, on execution, further cause the processor to:
receive user feedback corresponding to the output file, wherein the user feedback comprises scores corresponding to authenticity of content, the test data, and test flow; and
perform reinforcement learning (RL) on the pre-configured LLM based on the user feedback.

19. The system of claim 11, wherein the processor instructions, on execution, further cause the processor to:
transmit the output file to a deep segment model;
for each of the one or more test cases, segment one or more of the plurality of test steps using the deep segment model based on a set of predefined rules to obtain an updated plurality of test steps, wherein each of the one or more of the plurality of test steps comprises complex, and wherein the updated plurality of test steps comprises:
segmented test steps obtained upon segmenting the one or more of the plurality of test steps, and
remaining of the plurality of test steps; and
arrange the updated plurality of test steps in an order of precedence to obtain a valid test step flow.

20. A non-transitory computer-readable medium storing computer-executable instructions for automated test case generation, the computer-executable instructions configured for:
receiving one or more requirements in natural language from a user device, wherein each of the one or more requirements comprises an associated set of test scenarios;
generating one or more test cases for each requirement of the one or more requirements in a predefined template using a pre-configured Large Language Model (LLM), wherein each of the one or more test cases implements one of the associated set of test scenarios, and wherein each of the one or more test cases comprises a plurality of test steps, test data corresponding to each of the plurality of test steps, and expected results of each of the plurality of test steps;
validating the one or more test cases based on a set of test validation parameters, wherein the set of test validation parameters comprises test case functionality, test data, and scenario coverage; and
upon successful validation, generating an output file in a predefined format, wherein the output file comprises the one or more test cases.
